(19) United States
(12) Patent Application Publication
(10) Pub. No.: US 2025/0020126 A1
(43) Pub. Date: Jan. 16, 2025

(54) COMPRESSOR

(71) Applicant: DAIKIN INDUSTRIES, LTD., Osaka (JP)

(72) Inventors: Yoshiyuki UEMURA, Osaka (JP); Satoru TAKANEZAWA, Osaka (JP)

(21) Appl. No.: 18/900,159

(22) Filed: Sep. 27, 2024

Related U.S. Application Data
(63) Continuation of application No. PCT/JP2023/012745, filed on Mar. 29, 2023.

(30) Foreign Application Priority Data
Mar. 30, 2022 (JP) 2022-056517

(51) Int. Cl. F04C 29/06; F04C 18/16

(52) U.S. Cl. CPC F04C 29/068; F04C 18/16

(57) ABSTRACT

A compressor includes a casing that is horizontally elongated or vertically elongated, an electric motor housed in the casing, a compression mechanism driven by the electric motor to compress a refrigerant, a plurality of supporting portions arranged between an inner peripheral surface of the casing and an outer surface of the electric motor, and a reduction mechanism provided in the casing. The plurality of supporting portions support the electric motor in the casing. A plurality of predetermined spaces are formed between the inner surface of the casing and the outer surface of the electric motor. The plurality of predetermined spaces are separated by the supporting portions. The reduction mechanism reduces a resonant mode that is excited in the plurality of predetermined spaces by operation of the electric motor.

### CROSS-REFERENCE TO RELATED APPLICATIONS

This is a continuation of International Application No. PCT/JP2023/012745 filed on Mar. 29, 2023, which claims priority to Japanese Patent Application No. 2022-056517, filed on Mar. 30, 2022. The entire disclosures of these applications are incorporated by reference herein.

### BACKGROUND

### Technical Field

The present disclosure relates to a compressor.

### Background Art

A compressor including a compression mechanism configured to compress a refrigerant and an electric motor configured to drive the compression mechanism includes a casing in which the electric motor is fixed. For example, in Japanese Unexamined Patent Publication No. 2015-208164, a plurality of fastening portions circumferentially arranged on an inner wall of a casing are made thicker than the other portions, thereby supporting the electric motor in the casing. A plurality of spaces separated by the fastening portions are formed between the electric motor and the inner wall of the casing. Each of these spaces forms a gas flow path through which a refrigerant sucked into the compressor flows.

### SUMMARY

A first aspect of the present disclosure is directed to a compressor including a casing that is horizontally elongated or vertically elongated, an electric motor housed in the casing, a compression mechanism configured to be driven by the electric motor to compress a refrigerant, a plurality of supporting portions arranged between an inner peripheral surface of the casing and an outer surface of the electric motor, and a reduction mechanism provided in the casing. The plurality of supporting portions are configured to support the electric motor in the casing. A plurality of predetermined spaces are formed between the inner surface of the casing and the outer surface of the electric motor. The plurality of predetermined spaces are separated by the supporting portions. The reduction mechanism is configured to reduce a resonant mode that is excited in the plurality of predetermined spaces by operation of the electric motor.

### BRIEF DESCRIPTION OF THE DRAWINGS

FIG. 1 is a vertical sectional view of a schematic configuration of a screw compressor of an embodiment.

FIG. 2 is an external view showing how a screw rotor meshes with gate rotors.

FIG. 3A and FIG. 3B are cross-sectional views of the shape of a casing of a typical compressor. FIG. 3A is a cross-sectional view orthogonal to the longitudinal direction of the casing. FIG. 3B is a cross-sectional view taken along line III-III of FIG. 3A.

FIG. 4A and FIG. 4B are cross-sectional views of the shape of a casing of a compressor of the embodiment. FIG. 4A is a cross-sectional view orthogonal to the longitudinal direction of the casing. FIG. 4B is a cross-sectional view taken along line IV-IV of FIG. 4A.

FIG. 5 illustrates the shape of a cross section orthogonal to the longitudinal direction of a casing of a compressor according to a first variation.

FIG. 6 illustrates the shape of a cross section orthogonal to the longitudinal direction of a casing of a compressor according to a second variation.

FIG. 7A and FIG. 7B are cross-sectional views illustrating the shape of a casing of a compressor according to a third variation. FIG. 7A is a cross-sectional view orthogonal to the longitudinal direction of the casing. FIG. 7B is a cross-sectional view taken along line VII-VII of FIG. 7A.

FIG. 8A and FIG. 8B are cross-sectional views illustrating the shape of a casing of a compressor according to a fourth variation. FIG. 8A is a cross-sectional view orthogonal to the longitudinal direction of the casing. FIG. 8B is a cross-sectional view taken along line VIII-VIII of FIG. 8A.

FIG. 9A and FIG. 9B are cross-sectional views illustrating the shape of a casing of a compressor according to a fifth variation. FIG. 9A is a cross-sectional view orthogonal to the longitudinal direction of the casing. FIG. 9B is a cross-sectional view taken along line IX-IX of FIG. 9A.

FIG. 10A and FIG. 10B are cross-sectional views illustrating the shape of a casing of a compressor according to a sixth variation. FIG. 10A is a cross-sectional view orthogonal to the longitudinal direction of the casing. FIG. 10B is a cross-sectional view taken along line X-X of FIG. 10A.

FIG. 11A and FIG. 11B are cross-sectional views illustrating the shape of a casing of a compressor according to a seventh variation. FIG. 11A is a cross-sectional view orthogonal to the longitudinal direction of the casing. FIG. 11B is a cross-sectional view taken along line XI-XI of FIG. 11A.

### DETAILED DESCRIPTION OF EMBODIMENT(S)

An embodiment of the present disclosure will be described with reference to the drawings. The following embodiments are merely exemplary ones in nature, and are not intended to limit the scope, application, or uses of the invention. Features of the embodiments, variations, and other examples described below can be combined or partially substituted within the range where the present invention can be embodied. Some drawings may illustrate components in an enlarged scale for ease of understanding. Some drawings of cross-sectional views may omit hatching of components for ease of understanding.

### (1) General Configuration of Compressor

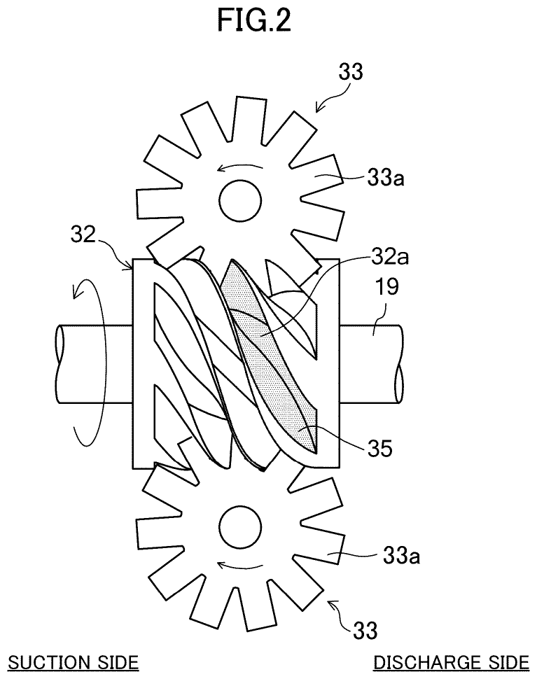

A compressor (10) of this embodiment is a screw compressor. The compressor (10) sucks a low-pressure gas refrigerant and compresses the sucked gas refrigerant. The compressor (10) discharges the compressed high-pressure gas refrigerant. As illustrated in FIG. 2, the compressor (10) of this example is a single screw compressor including one screw rotor (32). The compressor (10) is a two-gate compressor including two gate rotors (33, 33). The compressor (10) includes a casing (11), an electric motor (15), a drive shaft (19), and a compression mechanism (30).

### (1-1) Casing

The casing (11) is formed in a horizontally elongated tubular shape. The casing (11) has a low-pressure chamber (L) and a high-pressure chamber (H). The low-pressure chamber (L) is a space through which a low-pressure gas refrigerant to be sucked into the compression mechanism (30) flows. The low-pressure chamber (L) has a pressure equivalent to the pressure of a gas refrigerant to be sucked into the compression mechanism (30). The high-pressure chamber (H) is a space into which a high-pressure gas refrigerant discharged from the compression mechanism (30) flows. The high-pressure chamber (H) has a pressure equivalent to the pressure of a gas refrigerant discharged from the compression mechanism (30).

A suction cover (12) is attached to one of longitudinal ends of the casing (11). An opening (11a) is formed in the other one of the longitudinal ends of the casing (11). The opening (11a) is provided in a high-pressure region of the casing (11) where the high-pressure chamber (H) is formed.

The opening (11a) is closed by a fixing plate (13). The fixing plate (13) is a thick and substantially circular plate member. The axis of the fixing plate (13) substantially coincides with the axis of the drive shaft (19).

An oil separator (14) is attached to the other one of the longitudinal ends of the casing (11). The oil separator (14) separates oil from a refrigerant discharged from the compression mechanism (30). An oil reservoir chamber (14a) for storing oil is formed below the oil separator (14). The oil separated from a refrigerant in the oil separator (14) flows downward and is stored in the oil reservoir chamber (14a). The oil stored in the oil reservoir chamber (14a) has a high pressure almost equal to the discharge pressure of a refrigerant.

### (1-2) Electric Motor

The electric motor (15) is housed in the casing (11). The electric motor (15) has a stator (16) and a rotor (17). The stator (16) is fixed to the inner wall of the casing (11). The rotor (17) is disposed inside the stator (16). The drive shaft (19) is fixed inside the rotor (17).

The rotational speed of the electric motor (15) can be changed. In this example, the electric motor (15) is an inverter-driven electric motor. Specifically, the electric motor (15) is connected with an inverter device (18). The inverter device (18) changes the frequency of an AC power source, thereby changing the rotational speed of the electric motor (15).

### (1-3) Drive Shaft

The drive shaft (19) is housed in the casing (11). The drive shaft (19) is driven by the electric motor (15). The rotational speed of the drive shaft (19) varies as the rotational speed of the electric motor (15) varies. In other words, the rotational speed of the drive shaft (19) can be changed. The drive shaft (19) couples the electric motor (15) and the compression mechanism (30) together. The drive shaft (19) extends in the longitudinal direction of the casing (11). The drive shaft (19) extends in a substantially horizontal direction.

The drive shaft (19) is rotatably supported by a plurality of bearings (20). The drive shaft (19) has an intermediate portion supported by a first bearing (21). The first bearing (21) is fixed to the casing (11) via a bearing holder (not shown). The drive shaft (19) has a discharge-side end portion supported by a second bearing (22). The second bearing (22) is fixed to the casing (11) via a bearing holder (23). The bearing holder (23) has a substantially cylindrical shape surrounding the entire perimeter of the second bearing (22). The bearing holder (23) has a discharge-side end surface in contact with the fixing plate (13).

### (1-4) Compression Mechanism

The compression mechanism (30) includes one cylinder (31), one screw rotor (32), and two gate rotors (33).

The cylinder (31) is formed inside the casing (11). The screw rotor (32) is disposed inside the cylinder (31). The screw rotor (32) is fixed to the drive shaft (19). The screw rotor (32) rotates as the drive shaft (19) rotates. The screw rotor (32) has an outer peripheral surface on which three helical screw grooves (32a) are formed.

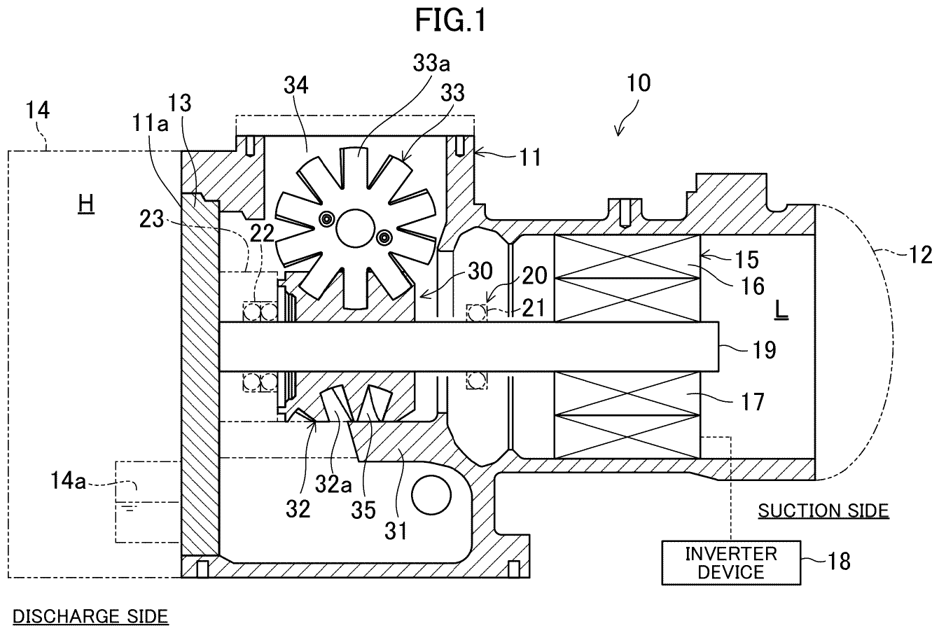

Outer peripheral surfaces of tooth tips of the screw rotor (32) are surrounded by the cylinder (31). One of axial ends of the screw rotor (32) (the right end in FIG. 1) faces the low-pressure chamber (L). The other one of the axial ends of the screw rotor (32) (the left end in FIG. 1) faces the high-pressure chamber (H).

The gate rotors (33) are housed in a gate rotor chamber (34). The gate rotors (33) each include a plurality of gates (33a) arranged radially. The gates (33a) of the gate rotor (33) pass through part of the cylinder (31) and mesh with the screw grooves (32a).

As illustrated in FIGS. 1 and 2, the compression mechanism (30) has an inlet and a compression chamber (35). The inlet is a portion of the screw groove (32a) that opens to the low-pressure chamber (L). The compression chamber (35) is formed by the inner peripheral surface of the cylinder (31), the screw groove (32a), and the gate (33a). In the compression mechanism (30), the refrigerant compressed in the compression chamber (35) is discharged to the high-pressure chamber (H) through an outlet.

The compression mechanism (30) includes a slide valve mechanism (not shown). The slide valve mechanism adjusts the timing of communication between the compression chamber (35) and the outlet. The slide valve mechanism includes a slide member (slide valve) that moves back and forth along the axial direction of the drive shaft (19). Part of the slide member is located in the high-pressure chamber (H).

### (2) Operation

An operation of the screw compressor (10) will be described with reference to FIGS. 1 and 2.

When the electric motor (15) drives the drive shaft (19), the screw rotor (32) rotates. As the screw rotor (32) rotates, the gate rotors (33) rotate. As a result, the compression mechanism (30) repeats a suction process, a compression process, and a discharge process in sequence.

### 1) Suction Process

In the compression mechanism (30), the volume of the screw groove (32a) communicating with the low-pressure chamber (L) increases. Accordingly, a low-pressure gas in the low-pressure chamber (L) is sucked into the screw groove (32a) through the inlet.

### 2) Compression Process

When the screw rotor (32) further rotates, the screw groove (32a) is formed by the gate rotor (33), and the compression chamber (35) is formed in the screw groove (32a). As the gate rotor (33) rotates, the volume of the compression chamber (35) decreases. Accordingly, the refrigerant in the compression chamber (35) is compressed.

### 3) Discharge Process

When the screw rotor (32) further rotates, the compression chamber (35) is opened. The refrigerant in the compression chamber is discharged to the high-pressure chamber (H) through the outlet.

By the above three processes repeating in sequence, a refrigerant is periodically discharged from the compression mechanism (30) to the high-pressure chamber (H).

When the inverter device (18) changes the rotational speed of the electric motor (15), the rotational speed of the screw rotor (32) coupled with the electric motor (15) via the drive shaft (19) changes.

### (3) Problems By Operation of Compressor

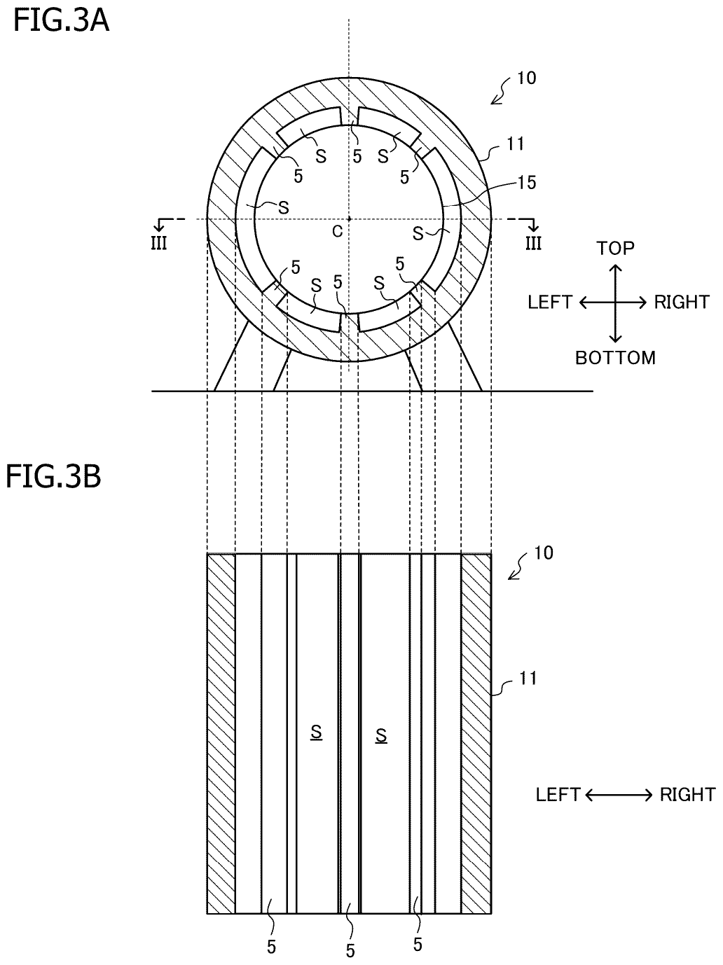

Problems caused by the operation of the compressor will be described with reference to FIG. 3A and FIG. 3B. In the following description, the terms “top,” “bottom,” “left,” and “right” refer to directions recognized when a cross section of the casing (11) orthogonal to the longitudinal direction is viewed from the front of the drawing. The center C of the casing refers to the center of a cross section of the casing (11) orthogonal to the longitudinal direction thereof.

In a compressor such as a screw compressor including the casing (11) that is horizontally elongated, the casing (11) has an inner peripheral surface having a plurality of supporting portions (5) that are raised portions and that are arranged circumferentially. Each supporting portion (5) extends in the longitudinal direction of the casing (11). The electric motor (15) is supported by the supporting portions (5), thereby being fixed in the casing (11). A plurality of spaces (acoustic spaces) (S) separated by the supporting portions (5) adjacent to each other in the circumferential direction are formed between the electric motor (15) and the inner peripheral surface of the casing (11). The refrigerant sucked into the compressor (10) flow through the acoustic spaces (S).

In terms of stable installation of the electric motor (15) and weight balance of the compressor, the plurality of supporting portions (5) are often arranged with vertical symmetry and horizontal symmetry. If six supporting portions (5) are provided on the inner peripheral surface of the casing (11), six acoustic spaces (S) are formed between the inner peripheral surface of the casing (11) and the electric motor (15). By the six supporting portions (5) being arranged with vertical symmetry, two acoustic spaces (S) on the left and the right have plane symmetry, and four acoustic spaces (S) on the top and the bottom have plane symmetry. The shapes of two or more acoustic spaces (S) having plane symmetry means that a vibration source is in a symmetric position. As a result, the resonance causes the casing (11) to vibrate more, and a louder radiated sound to the outside of the casing (11) causes the noise level to increase.

More specifically, in two or more of the plurality of acoustic spaces (S) having the same space shape (the same volume), the frequency bands in which vibration is excited overlap each other. Then, these acoustic spaces (S) excite a resonant mode, thereby causing the casing (11) to vibrate more. In particular, if such a plurality of acoustic spaces (S) are arranged with horizontal symmetry and vertical symmetry, the casing (11) vibrates more in the top-bottom direction and the left-right direction. Thus, it has been found that if the acoustic spaces (S) have the same space shape (volume) and the acoustic spaces (S) are arranged with plane symmetry, vibration and noise of the compressor increase.

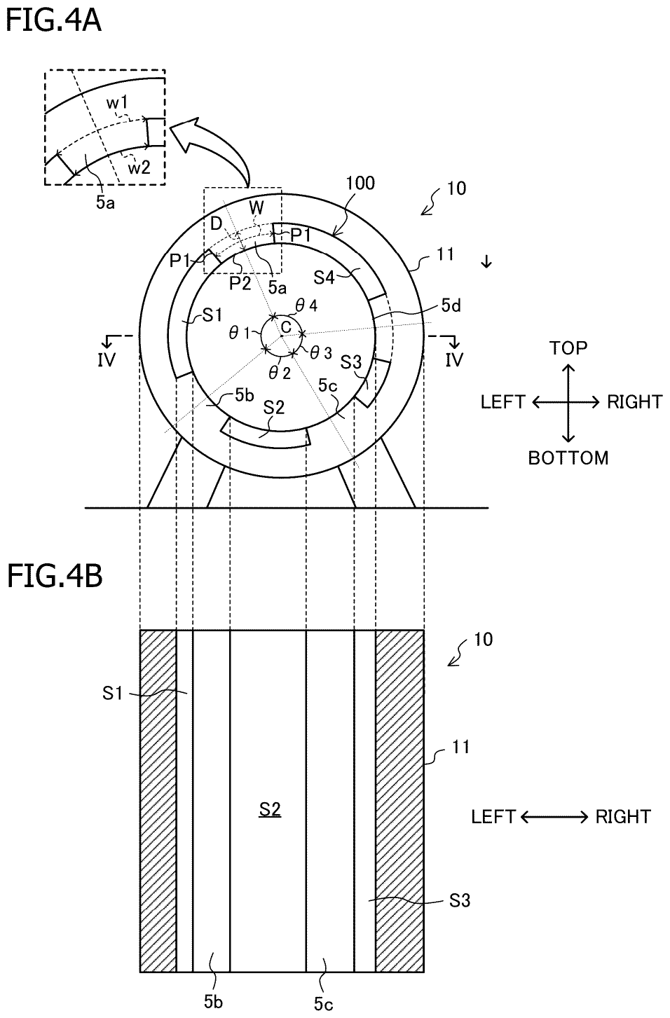

To address this problem, the compressor (10) of this embodiment includes a reduction mechanism (100) that is provided in the casing (11) and that is configured to reduce excitation of the resonant mode in the plurality of acoustic spaces (S). The specific description will be provided below with reference to FIG. 4A and FIG. 4B.

Similarly to a typical compressor, the compressor (10) of this embodiment includes the supporting portions (5) that fix the electric motor (15) in the casing (11). The supporting portions (5) are arranged between the inner peripheral surface of the casing (11) and the outer surface of the electric motor (15). Specifically, the supporting portions (5) are integrated with the casing (11). The supporting portions (5) extend in the longitudinal direction of the casing (11). The supporting portions (5) are raised portions extending linearly.

The compressor (10) of this embodiment includes four supporting portions (5) arranged in the circumferential direction of the casing (11). Specifically, as viewed from the front of the drawing, in the counterclockwise order from a first supporting portion (5a) located near the top of the casing (11), a second supporting portion (5b), a third supporting portion (5c), and a fourth supporting portion (5d) are arranged. Each supporting portion (5) includes two first end surfaces (P1) extending radially inward from the base (the inner peripheral surface of the casing) and one second end surface (P2) connecting the two first end surfaces (P1) at the radially inner ends. The second end surface (P2) is a surface that is in contact with the outer surface of the electric motor (15).

The four supporting portions (5) have the same shape. Specifically, all the supporting portions (5) have the same circumferential width W and the same radial length D. The circumferential width W is the circumferential length from one of the first end surfaces (P1) to the other one of the first end surfaces (P1) of each supporting portion (5). More specifically, the circumferential width W is the average of a circumferential length w1 from one of the first end surfaces (P1) to the other one of the first end surfaces (P1) at the radially outer end of the supporting portion (5) and the circumferential length w2 from one of the first end surfaces (P1) to the other one of the first end surfaces (P1) at the radially inner end of the supporting portion (5) (the circumferential length of the second end surface (P2)) (see the enlarged view surrounded by the dashed lines shown in FIG. 4A and FIG. 4B).

In this embodiment, four acoustic spaces (S) are formed. Specifically, a first acoustic space (S1) is formed between the first supporting portion (5a) and the second supporting portion (5b). A second acoustic space (S2) is formed between the second supporting portion (5b) and the third supporting portion (5c). A third acoustic space (S3) is formed between the third supporting portion (5c) and the fourth supporting portion (5d). A fourth acoustic space (S4) is formed between the fourth supporting portion (5d) and the first supporting portion (5a). The volume of each acoustic space (S) is the volume of a space that is sandwiched between the two supporting portions (5) adjacent each other and that extends from one of longitudinal ends to the other one of the longitudinal ends of the electric motor (15).

In the reduction mechanism (100) of this embodiment, each supporting portion (5) is arranged so that all the four acoustic spaces (S1 to S4) have different space volumes. Specifically, the angle between a first straight line passing through the center C of the cross section of the casing (11) and the middle of the first supporting portion (5a) and a second straight line passing through the center C of the cross section of the casing (11) and the middle of the second supporting portion (5b), where the cross section of the casing (11) is orthogonal to the longitudinal direction of the casing (11), is labeled “θ1.” The angle between the second straight line and a third straight line passing through the center C and the middle of the third supporting portion (5c) is labeled “θ2.” The angle between the third straight line and a fourth straight line passing through the center C and the middle of the fourth supporting portion (5d) is labeled “θ3.” The angle between the fourth straight line and the first straight line is labeled “θ4.” At this time, the supporting portions (5) are arranged so that the angles θ1, θ2, θ3, and θ4 are all different. Because of such arrangement, each of the four acoustic spaces (S1 to S4) has a different circumferential length, and thus all the four different acoustic spaces (S1 to S4) have different space volumes.

The reduction mechanism (100) of this embodiment does not provide an acoustic space (S) having plane symmetry on a longitudinal cross section of the casing (11). Further, all the four different acoustic spaces (S1 to S4) have different space volumes. Accordingly, overlapping of the frequency bands generated in the plurality of acoustic spaces (S) by operation of the electric motor (15) can be reduced, and thus the resonant mode excited in the plurality of acoustic spaces (S) can be reduced.

### (4) Features

### (4-1) First Feature

The compressor (10) of this embodiment includes the reduction mechanism (100) provided in the casing (11) and configured to reduce the resonant mode that is excited in the plurality of acoustic spaces (S) (spaces) by operation of the electric motor (15). In this manner, the resonant mode excited due to vibration transmitted to the plurality of acoustic spaces (S) by operation of the electric motor (15) can be reduced. As a result of reduction in the resonant mode, the casing (11) is less vibrated, and thus noise and vibration generated from the compressor (10) can be reduced.

### (4-2) Second Feature

In the reduction mechanism (100) of this embodiment, the four supporting portions (5) are arranged so that all the acoustic spaces (S) have different space volumes. If the plurality of acoustic spaces (S) have the same space volume, the frequency bands where vibration is excited overlap each other, and thus the vibrating force (the resonant mode) increases. However, if the supporting portions (5) are arranged so that all the acoustic spaces (S) have different space volumes, the frequency bands can be shifted so that the frequencies generated in the acoustic spaces (S) do not overlap each other. Accordingly, noise and vibration of the compressor can be reduced more effectively.

### (4-3) Third Feature

In the compressor (10) of this embodiment, the supporting portions (5) are formed on the inner peripheral surface of the casing (11). Accordingly, the supporting portions (5) and the casing (11) can be integrated together, and thus the compressor (10) can be manufactured more easily.

### (4-4) Fourth Feature

In the compressor (10) of this embodiment, the electric motor (15) is driven at a variable frequency. If the frequency of the electric motor (15) is changed, the frequency of vibration transmitted to the acoustic spaces (S) is also varied. However, all the acoustic spaces (S) of this embodiment have different space volumes, and thus even if the frequency of the electric motor (15) is changed, overlapping of the frequency bands where vibration is excited in the acoustic spaces (S) can be reduced. In this manner, the reduction mechanism (100) of this embodiment is configured to be capable of reducing the resonance mode at any frequencies of the electric motor (15), and thus noise and vibration can be reduced effectively.

### (4-5) Fifth Feature

The compressor (10) of this embodiment is a screw compressor having the compression chamber (35) formed by the gate rotor (33) and the screw groove (32a). The screw compressor (10) including the reduction mechanism (100) that reduces vibration and noise can be provided.

### (4-6) Sixth Feature

The screw compressors (10) of this embodiment includes three screw grooves (32a). Even if three screw grooves are provided, the reduction mechanism (100) of this embodiment can reduce the vibrating force (pulsation frequency) per groove generated by a sucked refrigerant or a discharged refrigerant, and thus the resonant mode can be reduced.

### (5) Variations

The above embodiment may also be configured as follows. Only the configurations different from those of the above embodiment will be described below.

### (5-1) First Variation

A reduction mechanism (100) of a first variation includes four supporting portions (5), one of which has the ratio (W/D) of the circumferential width W to the radial length D that is different from those of the other three supporting portions (5).

For example, as illustrated in FIG. 5, the supporting portions (5) are formed so that W1/D1 is different from W2/D2, W3/D3, and W4/D4, where the first supporting portion (5a), the second supporting portion (5b), the third supporting portion (5c), and the fourth supporting portion (5d) have the circumferential widths W1, W2, W3, and W4, respectively, and have the radial lengths D1, D2, D3, and D4, respectively.

By the supporting portions (5) being arranged as described above so that the angles θ1, θ2, θ3, and θ4 are all different from each other and so that the ratio W1/D1 of the first supporting portion (5a) is different from those of the other supporting portions (5), the four different acoustic spaces (S1 to S4) are enabled to have different space volumes and different space shapes (the cross-sectional shapes of the acoustic spaces as viewed from the front of the drawing of FIG. 5). Accordingly, the resonant mode excited by the plurality of acoustic spaces (S) can be reduced.

### (5-2) Second Variation

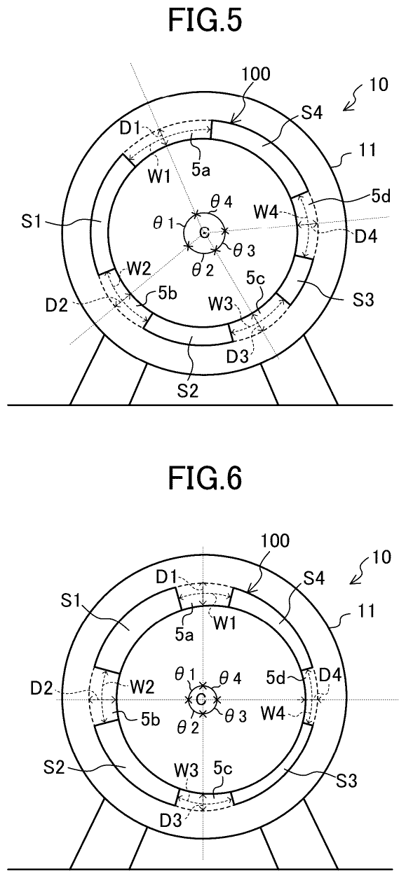

As illustrated in FIG. 6, a reduction mechanism (100) of a second variation has the angles θ1, θ2, θ3, and θ4 that are all equal to each other, and includes four supporting portions (5) of which the ratios W/D are all different from each other.

In this manner, the angles θ1 to θ4 are equal to each other, and thus the first acoustic space (S1) to the fourth acoustic space (S4) are arranged with plane symmetry. However, the ratios W/D of the four supporting portions (5) are all different from each other, and thus the first acoustic space (S1) to the fourth acoustic space (S4) are enables to have different space volumes and different space shapes. Accordingly, the resonant mode excited by the plurality of acoustic spaces (S) can be reduced.

### (5-3) Third Variation

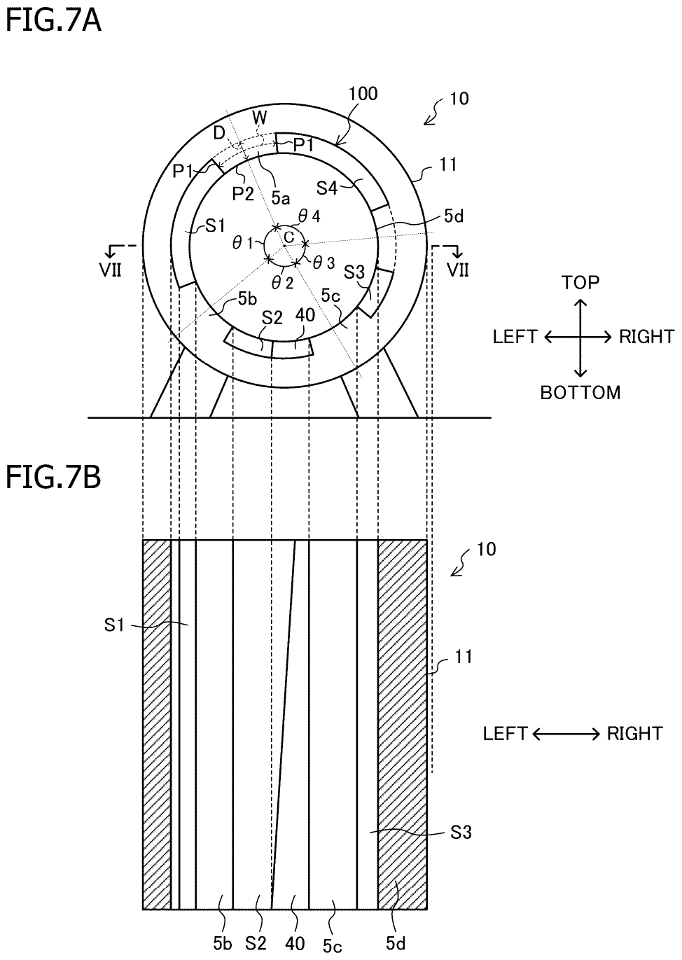

As illustrated in FIG. 7A and FIG. 7B, a reduction mechanism (100) of a third variation includes a first member (40) where the cross-sectional shape of the first member (40) orthogonal to the longitudinal direction of an acoustic space (S) varies in the longitudinal direction of the acoustic space (S).

The first member (40) is disposed in at least one of the acoustic spaces (S). The first member (40) is a plate-shaped member extending in the longitudinal direction of the acoustic space (S). For example, the first member (40) becomes gradually thinner or gradually thicker from one of longitudinal ends toward the other one of the longitudinal ends thereof. The space volume of the acoustic space (S) in which the first member (40) is provided is reduced by the volume of space occupied by the first member (40). By the shape of the first member (40) being designed in this manner in accordance with the space volume of the acoustic space (S), the acoustic space (S) in which the first member (40) is provided can be made different in space volume from the other acoustic spaces (S).

This first member (40) can be used also for a compressor (10) having acoustic spaces (S), all of which are arranged with plane symmetry and have the same space volume. This compressor (10) allows the resonant mode to be excited in the plurality of acoustic spaces (S), but enables the acoustic space (S) in which the first member (40) is provided to be different in space volume from the other acoustic spaces (S). In this case, each of the plurality of acoustic spaces (S) in one preferred embodiment includes a first member (40) having a different shape. Accordingly, the space volumes of the acoustic spaces (S) can be made different from each other.

In addition, the cross-sectional area of the acoustic space (S) in which the first member (40) is provided varies from one of longitudinal ends toward the other one of longitudinal ends thereof. In other words, the area of the cross section of a flow path (the cross section of a space) with respect to the direction in which refrigerant gas flows varies. In this acoustic space (S), the velocity of flow of refrigerant gas varies, but thus noise and vibration of the compressor (10) can be more effectively reduced than if the velocity of flow of refrigerant gas is constant.

### (5-4) Fourth Variation

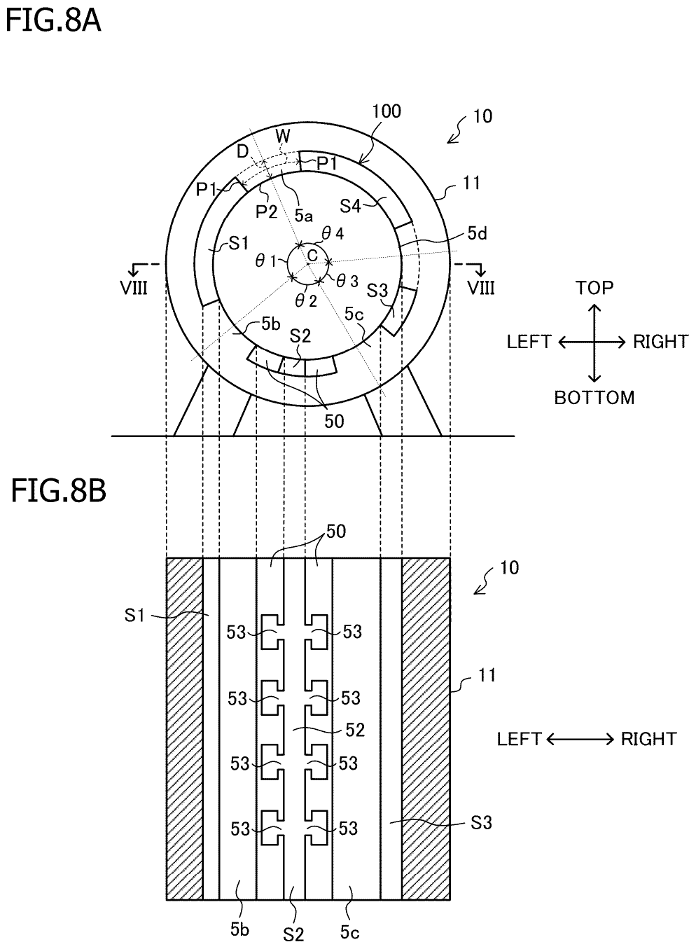

As illustrated in FIG. 8A and FIG. 8B a reduction mechanism (100) of a fourth variation further includes a silencing mechanism (50) provided in an acoustic space (S).

The silencing mechanism (50) is a plate-shaped member provided along the longitudinal direction of the acoustic space (S). In the acoustic space (S) in which the silencing mechanism (50) is installed, a plurality of secondary flow paths (53) branching from a main flow path (52) through which refrigerant gas flows is formed between one of and the other one of ends the acoustic space (S). Each secondary flow path (53) has a dead end. Accordingly, in the acoustic space (S) in which the silencing mechanism (50) is provided, noise is reduced because of the Helmholtz effect.

### (5-5) Fifth Variation

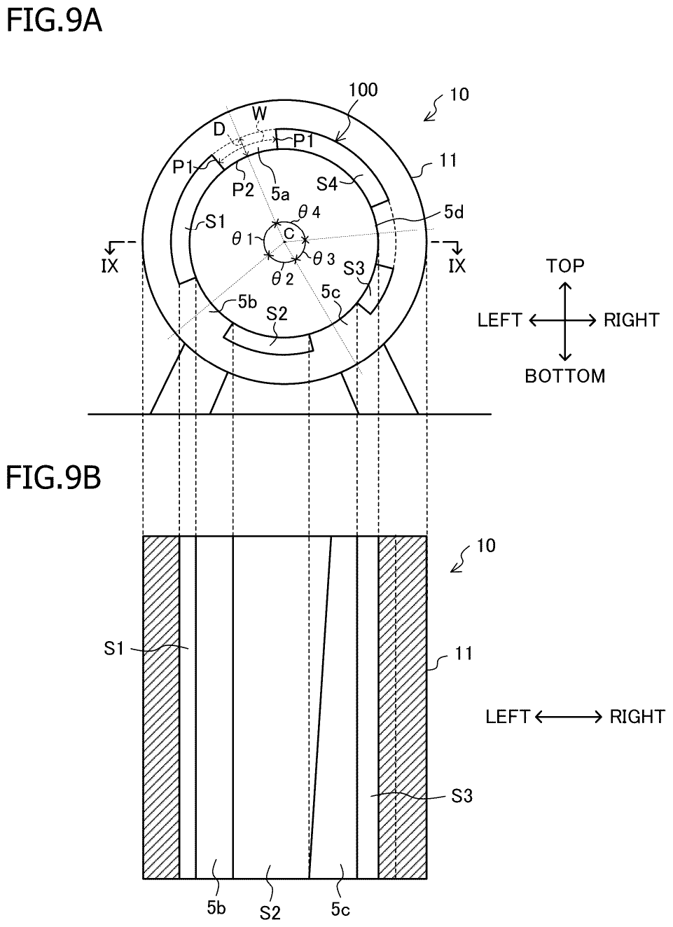

As illustrated in FIG. 9A and FIG. 9B, a reduction mechanism (100) of a fifth variation includes supporting portions (5), where the cross-sectional shape of each supporting portion (5) orthogonal to the longitudinal direction varies in the longitudinal direction. These supporting portions (5) enables each of the four acoustic spaces (S1 to S4) to have a different space volume.

For example, even if the compressor (10) of the above embodiment includes the four supporting portions (5) arranged so that the angles θ1 to θ4 are equal to each other, the four supporting portions (5), where the cross-sectional shape of each supporting portion (5) varies from one longitudinal end and the other longitudinal end and where each supporting portion (5) has a different cross-sectional shape, enables each of the four acoustic spaces (S1 to S4) to have a different space volume and enables the cross-sectional shape of the acoustic space (S) orthogonal to the longitudinal direction to vary from one longitudinal end and the other longitudinal end.

Of the plurality of supporting portions (5) provided in the compressor (10), one supporting portion (5) or two or more supporting portions (5) may be formed like the supporting portion (5) of this example.

### (5-6) Sixth Variation

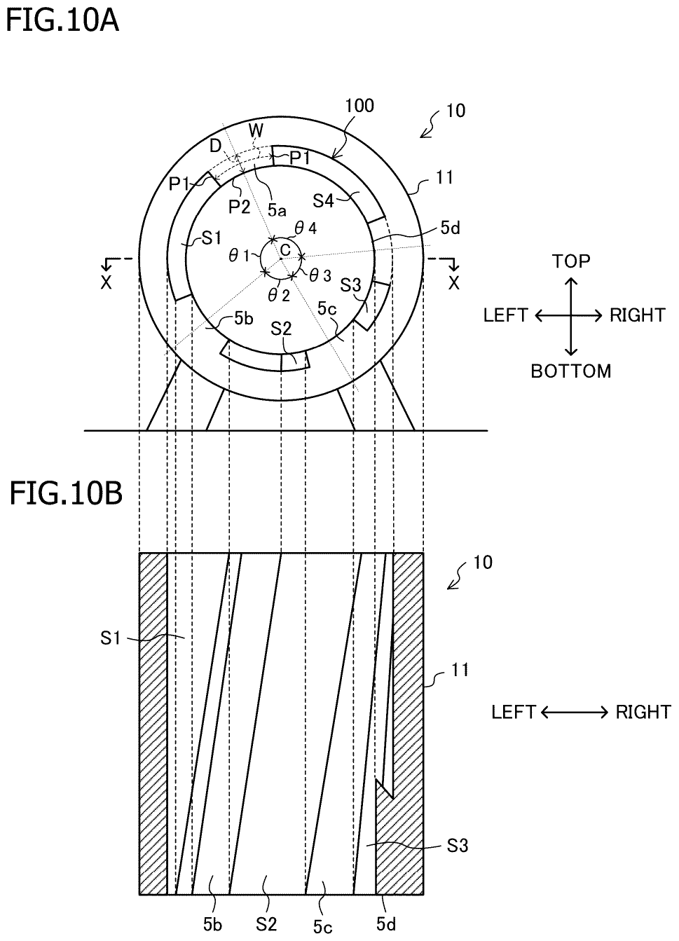

As illustrated in FIG. 10A and FIG. 10B, a reduction mechanism (100) of a sixth variation includes supporting portions (5) each having a helical shape in the longitudinal direction. Accordingly, the acoustic space (S) forms a helical flow path of which the length can be greater than if refrigerant gas flows linearly, and thus the space resonant frequency can be modulated.

### (5-7) Seventh Variation

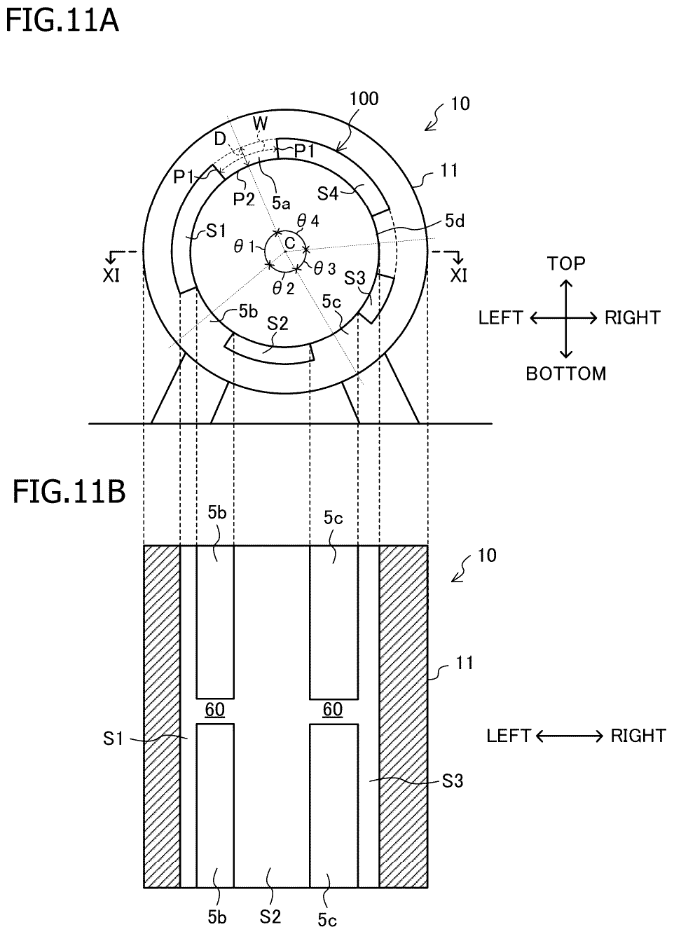

As illustrated in FIG. 11A and FIG. 11B, a reduction mechanism (100) of an eighth variation includes supporting portions (5) each having a communication passage (60) that communicates the acoustic spaces (S) adjacent to each other in the circumferential direction of the casing (11). Accordingly, the cross section of the acoustic space (S) become larger in the communication passage (60), and thus refrigerant gas flowing through the acoustic space (S) expands in the communication passage (60). By the plurality of communication passages (60) being provided, refrigerant gas flowing through the acoustic space (S) expands and contracts repeatedly, and consequently noise can be reduced.

### (6) Other Embodiments

The compressor (10) may be a rotary compressor or a scroll compressor. In this case, the casing (11) of the compressor (10) is vertically elongated.

In the above embodiment and variations, the supporting portion (5) may include three supporting portions (5) or may include five or more supporting portions (5). The number of support portions (5) is greater in one preferred embodiment. As the number of supporting portions (5) is greater, the number of acoustic spaces (S) is greater accordingly. As the number of acoustic spaces (S) is greater, the frequency generated in each acoustic space (S) shifts to a higher frequency region. By the frequency shifting to a higher frequency region, the casing (11) can be less vibrated accordingly.

In the above embodiment and variations, the number of supporting portions (5) is a prime number in one preferred embodiment. In consideration that the spaces in the compressor work together, the number of supporting portions (5) being set to a prime number can reduce the vibrating force. Specifically, if the number of functional components of the screw compressor (the number of screw grooves, the number of suction ports or discharge ports, the number of spokes retaining bearings, the number of supporting portions (5), and the like) is determined, the layout of the spaces formed in the casing is defined accordingly. At this time, if there are some functional components of which the number is a common divisor, the spaces in which the functional component are provided work together, and thus the resonant mode is excited. As a result, the vibrating force by the resonant mode become greater than if the spaces do not work together. Thus, by the number of supporting portions (5) being set to a prime number, the spaces less work together, and consequently, excitation of the spaces can be reduced simultaneously.

In the above embodiment, the supporting portions (5) may be provided on the outer peripheral surface of the electric motor (15). In other words, the supporting portions (5) may form part of the outer peripheral surface of the electric motor (15).

In the above embodiment, the reduction mechanism (100) may include a plurality of acoustic spaces (S), at least one of which is different in length in the longitudinal direction of the casing (11) from the other acoustic spaces (S). Specifically, at least one of the four supporting portions (5) may be different in longitudinal length from the other supporting portions (5). For example, the first supporting portion (5a) may be shorter in the longitudinal direction of the casing (11) than the other supporting portions (5). By the length of some of the supporting portions (5) being changed as described above, the supporting portion (5) can be made different in space volume from the other acoustic spaces (S).

In the first variation, two of the supporting portions (5) may have different ratios (W/D) of the circumferential width W to the radial length D. Alternatively, all the supporting portions (5) may have different ratios W/D.

The reduction mechanism (100) of the first variation may include four acoustic spaces (S1 to S4), at least one of which is different in radial length from the other acoustic spaces. For example, the first supporting portion (5a) may have a circumferential width W1 equal to the other three circumferential widths (W2 to W4) and a radial length D1 different from the other three radial lengths (D2 to D4).

The reduction mechanism (100) of the first variation may include four acoustic spaces (S1 to S4), at least one of which is different in circumferential length from the other acoustic spaces. For example, the first supporting portion (5a) may have a radial length D1 equal to the other three radial lengths (D2 to D4) and a circumferential width W1 different from the other three circumferential widths (W2 to W4).

The reduction mechanism (100) of the first variation may include four acoustic spaces (S1 to S4), at least one of is different in radial length and circumferential length from the other acoustic spaces. For example, the first supporting portion (5a) may have a radial length D1 different from the other three radial lengths (D2 to D4) and a circumferential width W1 different from the other three circumferential widths (W2 to W4).

In the second variation, the first supporting portion (5a) to the fourth supporting portion (5d) may have four circumferential widths (W1 to W4) equal to each other and four radial lengths (D1 to D4) different from each other. The first supporting portion (5a) to the fourth supporting portion (5d) may have four radial lengths (D1 to D4) equal to each other and four circumferential width (W1 to W4) different from each other. The first supporting portion (5a) to the fourth supporting portion (5d) may have four circumferential widths (W1 to W4) different from each other and four radial lengths (D1 to D4) different from each other.

In the above embodiment and variations, the reduction mechanism (100) only has to reduce excitation of the resonant mode in at least one of the acoustic spaces (S) occupying half or more of the total volume of all the acoustic spaces (S1 to S4). As the space volume of the acoustic space (S) is larger, vibration and noise generated by the excitation of the resonant mode are larger. Thus, reduction in the resonant mode in the acoustic spaces (S) occupying half or more of the total volume enables reduction in noise and vibration of the compressor.

In the above embodiment, the screw groove (32a) may include six screw grooves (32a). The pulsation frequency of six screw grooves has a wavelength shorter than that of three screw grooves, and the vibrating force generated by a sucked refrigerant or a discharged refrigerant is reduced accordingly. Adding the reduction mechanism (100) can lead to further reduction in noise and vibration.

In the above embodiment, the compressor (10) may be a screw compressor including two screw rotors (32) or may be a screw compressor including three screw rotors (32).

While the embodiment and variations thereof have been described above, it will be understood that various changes in form and details may be made without departing from the spirit and scope of the claims. The above embodiment and variations thereof may be combined or replaced with each other without deteriorating the intended functions of the present disclosure. The expressions of “first,” “second,” . . . described above are used to distinguish the terms to which these expressions are given, and do not limit the number and order of the terms.

As described above, the present disclosure is useful for a compressor.

1. A compressor comprising:
a casing that is horizontally elongated or vertically elongated;
an electric motor housed in the casing;
a compression mechanism configured to be driven by the electric motor to compress a refrigerant;
a plurality of supporting portions arranged between an inner peripheral surface of the casing and an outer surface of the electric motor, the plurality of supporting portions being configured to support the electric motor in the casing; and
a reduction mechanism provided in the casing,
a plurality of predetermined spaces being formed between the inner surface of the casing and the outer surface of the electric motor, the plurality of predetermined spaces being separated by the supporting portions, and
the reduction mechanism being configured to reduce a resonant mode that is excited in the plurality of predetermined spaces by operation of the electric motor.

2. The compressor of claim 1, wherein
the reduction mechanism reduces excitation of the resonant mode in at least one of the predetermined spaces occupying half or more of a total volume of all the predetermined spaces.

3. The compressor of claim 1, wherein
the reduction mechanism includes the plurality of supporting portions arranged so that all the predetermined spaces have different volumes.

4. The compressor of claim 2, wherein
the reduction mechanism includes the plurality of supporting portions arranged so that all the predetermined spaces have different volumes.

5. The compressor of claim 1, wherein
the supporting portions are formed on the inner peripheral surface of the casing.

6. The compressor of claim 1, wherein
in the reduction mechanism, at least one of the plurality of predetermined spaces is different in radial length from the other predetermined spaces.

7. The compressor of claim 1, wherein
in the reduction mechanism, at least one of the plurality of predetermined spaces is different in circumferential length from the other predetermined spaces.

8. The compressor of claim 1, wherein
in the reduction mechanism, at least one of the plurality of predetermined spaces is different in length in a longitudinal direction of the casing from the other predetermined spaces.

9. The compressor of claim 1, wherein
the reduction mechanism further includes a first member, and a cross-sectional shape of the first member orthogonal to a longitudinal direction of the predetermined space varies in the longitudinal direction of the predetermined space.

10. The compressor of claim 1, wherein
the reduction mechanism further includes a silencing mechanism provided in the predetermined spaces.

11. The compressor of claim 1, wherein
the number of plurality of supporting portions arranged in the casing is a prime number.

12. The compressor of claim 1, wherein
a cross-sectional shape of each of the supporting portions orthogonal to a longitudinal direction varies along the longitudinal direction.

13. The compressor of claim 1, wherein
the supporting portions each have a helical shape in a longitudinal direction.

14. The compressor of claim 1, wherein
the supporting portions each have a communication passage that communicates the predetermined spaces adjacent to each other in a circumferential direction of the casing.

15. The compressor of claim 1, wherein
the electric motor is driven at a variable frequency.

16. The compressor of claim 1, wherein
the casing includes a cylinder,
the compression mechanism includes
a screw rotor inserted into the cylinder and having a screw groove, and
a gate rotor meshing with the screw groove, and
in the cylinder, a compression chamber is formed by the gate rotor and the screw groove.

17. The compressor of claim 16, wherein
the screw groove includes three screw grooves.

18. The compressor of claim 16, wherein
the screw groove includes six screw grooves.

19. The compressor of claim 16, wherein
the screw rotor includes one screw rotor, two screw rotors, or three screw rotors.
